(19) United States
(12) Patent Application Publication
(10) Pub. No.: US 2020/0087590 A1
(43) Pub. Date: Mar. 19, 2020

(54) SYSTEM FOR, METHOD OF, AND THE RESULTING PRODUCT OF THE PRODUCTION OF FUEL GAS, HEAT AND ELECTRICITY AND THE CLEANING OF CARBON EMISSIONS

(71) Applicants: Nicola Puma, Salemi (IT); Giuseppe Ilardi, Salemi (IT); Francesco Li Gregni, San Giovannia Gremini (IT)

(72) Inventors: Nicola Puma, Salemi (IT); Giuseppe Ilardi, Salemi (IT); Francesco Li Gregni, San Giovannia Gremini (IT)

(73) Assignee: Syntactic Dream Energy, LLC, Old Bridge, NJ (US)

(21) Appl. No.: 16/130,792

(22) Filed: Sep. 13, 2018

(51) Int. Cl. C10L 3/08; C25B 1/04; C25B 15/08; C10L 3/10; F23C 13/06; B01D 53/02; B01D 53/14

(52) U.S. Cl. CPC C10L 3/08; B01D 2257/502; C25B 15/08; C10L 3/104; C10L 3/106; F23C 13/06; B01D 53/02; B01D 53/14; C10L 2290/02; C10L 2290/06; C10L 2290/10; C10L 2290/24; C10L 2290/38; C10L 2290/547; F23C 2700/04; B01D 2257/504; C25B 1/04

(57) ABSTRACT

The field of present invention generally relates to furnaces that combine fuel production with both thermal and electrical energy production. They also are capable of using carbon emission as part of the production process. More particularly, the present invention produces a combustible gas that, within the internal workings of the present invention, can efficiently be burned at relatively lower temperatures and pressures without the production of high levels of pollutants. Further, the present invention can receive what are ordinarily wasteful carbon emissions for use in the production of more desirable outputs. The foregoing characteristics, along with the limited size of the elements needed to practice the present invention, make it conducive for use as and in connection with, among other things, residential furnaces and other heating systems, including, for example, heat exchangers and residential hot water tanks. In short, the present invention involves the production of a combustible fuel gas, and of thermal and electric energy, and the productive use of carbon emissions. This production is accomplished through the interconnected use of water electrolysis, catalysts, storage means, regulation, and mean of reusing materials to increase production efficiencies.

### FIELD OF THE INVENTION

The present invention relates to the production of a combustible gas. Heat and electricity can also be produced by the practice of the present invention. The system and method involves use of primary gases in a thermochemical-catalyzed reaction. The primary gases are produced by water electrolysis. The resulting combustible gas has physical characteristics that allow the product to be produced, stored, transported and use cost effectively and safely. Further, the present invention relates also to the use of the combustible gas (i.e., the product of the process) as fuel for electricity and thermal energy production for domestic and industrial purposes, as fuel for transportation applications, and in connection with renewable energy storage.

### BACKGROUND OF THE INVENTION

The systems and methods employed to produce heat, electricity and power have improved as the consumption of all three of these and other expressions of energy have increased. Some of this energy is created following the production of combustible gas. Such gas is, at times, produced for the generation of thermal and electric energy in stationary devices, for applications in the transportation field, for the production of heat, air and hot water and electric energy, even from renewable source, or for a combination of the foregoing. Particular examples include the uses of furnaces for the production of air and hot water. The production of combustible gas has also been vital for the sectors of cogeneration of electricity, renewable energy storage, and thermal energy and for use as fuels for transport means and propelled in general.

In general, existing furnaces generate heat by a gaseous, liquid or solid fuel that is provided from either a supply network (e.g., piping built to transport natural gas to residences) or suitably sized tanks and storage spaces that house the fuel(s) (e.g., propane tanks storing fuel for residential power outage situations). As a result, such furnaces are typically not operated in the places where (A) these fuels are not available via a supply network and (B) the space for sufficient storage tanks is limited or nonexistent. Moreover, such furnaces do not typically generate by themselves the combustible gas or other combustible liquids or solids.

Another aspect of this field is the need to operate the equipment used to produce combustible gases at high temperatures, under high pressure, or both. For example, reference is made to the process discussed in US Patent Application Nos. US20160107952A1 [Schulz], US20160053388A1 [Reytier], and US20140000157A1, and U.S. Pat. Nos. 8,506,910B2 and 7,989,507B2. Each of the following references teaches the use of high temperatures and high pressures in the creation of their respective products. These productions parameters, however, inherently limited the suitability of the disclosed processes in many residential settings and in smaller spaces (e.g., as part of the power plant of a motor vehicle). Since the 1950s, several commercial companies have been using methanation processes, procedures and devices in several industrial applications (ammonia production, synthesis gas purification), but none with the highest possible cost and energy efficiencies).

More specifically, although US 20160053388 discloses methods for producing combustible gas from the electrolysis of water (HTE) or co-electrolysis with H₂O/CO₂ in the same chamber, and associated catalytic reactor and system, the Reytier process utilizes as initiators methane, methanol, dimethyl ether (DME) or diesel by heterogeneous catalysis. Reytier's process also comprises a step of high temperature water electrolysis (HTE for “High Temperature Electrolysis” or HTSE for “High Temperature Steam Electrolysis”) or a step known as co-electrolysis of water and carbon dioxide CO₂ at high temperature and a step of manufacturing combustible gas by catalytic reaction, utilizing temperatures that are relatively high. The Reytier teachings are also more particularly focused on a design of reactor, with its pressure chamber houses, with disparate steps of the catalytic conversion and gases injected in any space between the electrolysis reactor and the radial reaction zone, the performance of the higher temperatures electrolysis (compared to the present invention).

Although US 20080275278 [Clark] may show a system for the controlled combustion of a wide variety of hydrocarbon feedstocks to produce thermal energy, liquid fuels, and other valuable products with little or no emissions, in Clark, the hydrocarbon feeds, such as coal and biomass, are first gasified and then oxidized in a two-chamber system/process using pure oxygen rather than ambient air, producing carbon monoxide, hydrogen and carbon dioxide by the use of the Fischer-Tropsch process (a collection of chemical reactions that converts a mixture of carbon monoxide and hydrogen into liquid hydrocarbons).

US 2010/0175320 A1 [Schuetzle] discloses blends of synthetic diesel fuel and petroleum diesel fuel with improved performance characteristics and teaches a system and apparatus that maximizes mass and energy conversion efficiencies in an integrated thermochemical process for the conversion of fossil fuel or renewable biomass to synthesis gas. The Schuetzle system combines gasification, catalytic conversion of gas to liquid, electricity generation, steam and chilled water generation with a system controller to maximize the conversion efficiency from syngas to merchantable products over the efficiency of syngas alone burned as a fuel. This technology thus does not holistically address the shortcomings of the prior art (e.g., neither Schulz nor Kaneeda teaches nor suggests cost and energy efficient use of methanation or water electrolysis. The references specifically cites the general principle of methanation temperatures ranging knowledge between 300° C. and 700° C. Furthermore Schulz discloses a system in which an electrolyzer and methanator need a heat source and teaches the generation of a methane stream from the methanator.

Another aspect of this field is the nature of the combustible gases. Some of the processes employed to produce combustible gases create a resulting product that is highly combustible and more unstable. Such gases are difficult and expensive to transport, present multiple safety concerns regarding their storage, and are practical for use in unsophisticated business environments, by residences and to power motor vehicles.

The present invention, addressing the foregoing, consists of embodiments of systems and methods that can intake fuel that is originally sourced from a supply network, a small storage tank, produced at least in part of the systems and methods themselves, or a combination of the foregoing. The same systems and methods can be operated at temperatures and pressures that are suitable for residences and other locations (e.g., motor vehicles), with less concern despite the potential residential setting and the smaller size of the space. The resulting product of the various embodiments of the systems and methods that is suitable for cost-efficient and safe transport, storage and use.

### BRIEF SUMMARY OF THE INVENTION

The present invention comprises a series of systems, methods and products in the field of fuel. In one embodiment of the process, through which a combustible gas is efficiently (>80% efficiency) produced (without producing polluting emissions from fossil hydrocarbons), the steps include (A) producing primary gases by water electrolysis, (B) mixing and filtering such primary gases, (C) internally producing CO₂ gas, (D), storing such CO₂ gas, (E) mixing the filtered primary gases with the previously produced CO₂ gas (and CO gas) in a catalytic reaction at a temperature above 15° C. and below 500° C. and at a pressure higher than 1 bar and lower than 10 bar wherein the gas mixture is conveyed over the surface of a desired catalyst, (F) releasing undesired/unneeded molecules, (G) collecting the final gas formulation, having the desired chemical and physical properties, (H) recovering water produced through the process, and (I) recovering any residual CO₂ gas for use in the process in combination with the produced/stored CO₂ gas. In an additional embodiment, the steps of internal producing and storing of the CO₂ are more distinguishable and it is the internally produced CO₂ (without the CO gas) that is mixed in the filtered primary gases in the catalytic reaction.

In one embodiment of the system, through which combustible gas with the same properties is produced with the same efficiencies, the elements include (A) a means of producing primary gases through water electrolysis, (B) a means of mixing and filtering such primary gases, (C) a means of producing CO₂ gas, (D) storing such CO₂ gas, (E) a means of mixing the filtered primary gases with the previously produced CO₂ gas (and CO gas) in a catalytic reaction at a temperature above 15° C. and below 500° C. and at a pressure higher than 1 bar and lower than 10 bar, (F) a means of conveying the primary gas/CO₂/CO gas mixture over the surface of a desired catalyst, (G) a means of releasing undesired/unneeded molecules, (H) a means of collecting the final gas formulation with the desired chemical properties, (I) a means of recovering water produced through the process, and (J) a means of recovering any residual CO₂ gas for use in the process in combination with the produced/stored CO₂ gas. In an additional embodiment, the system includes a CO₂ producing means that is separate from the CO₂ storing means. Also in that embodiment, the means for mixing the filtered primary gases need mix them with the internally produced CO₂ (without to need to have the capability of mixing in CO gas) that is mixed in the catalytic reaction.

A third aspect of the present invention is a combustible gas, produced through the use of one or more of the systems and/or methods described herein, that is suitable for cost-efficient and safe transport, storage and use.

There are also other specific and distinctive elements of the present invention that separate it from the teaching of the prior art. The present invention produces only methane (no other resulting gases). The present invention has no SOEC cell stack, nor does the inventive system have porous partition, a radial layout nor a need to (1) feed gas under pressure or (2) inject any CO₂ into the main reactor. The present invention also does not have a porous partition, or concentrically arranged elements or layout, since the methanation reactor is embedded into a single device performing electrolysis.

Other prior art also fails to not disclose other aspects of the present invention. For example, the present invention produces combustible gas (mainly methane) using electrolysis, graphite oxidation and a methanation reaction that does not include gasification, combustion, or the Fischer-Tropsch process. The present invention uses only water and graphite (or high purity coal) as feedstocks (i.e., no liquid, solid fuels are used and no intermediate products are produced).

Differing from Schuetzle, the present invention includes a system that produces combustible gas, mostly methane (a few parts of H₂ and CO as reaction co-products), through the use of electrolysis, graphite oxidation and a methanation reaction (not through gasification or the catalytic conversion of gas to liquid).

### BRIEF DESCRIPTION OF THE DRAWINGS

The components and the advantages related to the present invention will be better depicted by referring to the drawings, in which:

FIG. 1 is a block diagram of a system for gas production integrated with a furnace operating in cogeneration mode with high efficiency and reduced emissions.

FIG. 2 is a functional diagram of a system for gas production with integrated furnace operating in cogeneration mode with high efficiency and low emissions.

FIG. 3 is a functional diagram of the control system of a gas production system integrated with the furnace operating in cogeneration mode with high efficiency and reduced emissions.

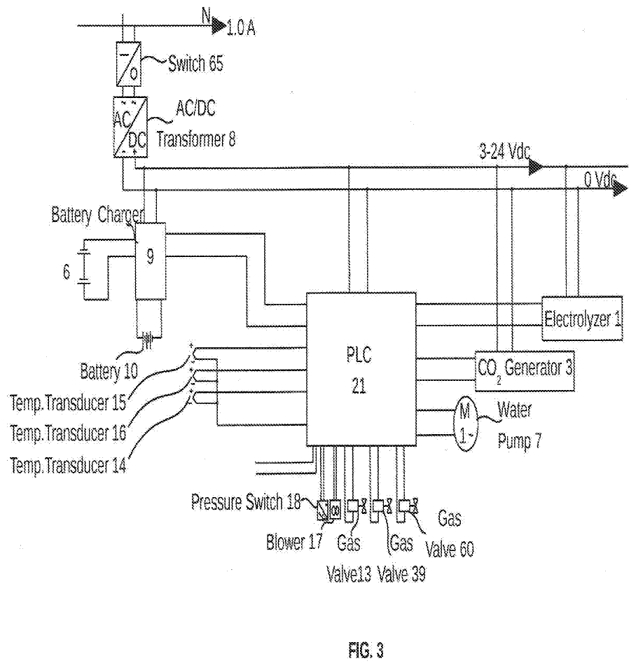

FIG. 4 is second block diagram of a preferred embodiment of a system for gas production integrated with a furnace operating in cogeneration mode with high efficiency and reduced emissions.

### DESCRIPTION OF THE PREFERRED EMBODIMENTS

The present invention provides the fuel used for the generation of both electricity and heat, as a fuel for cogeneration, renewable energy storage, transportation, and potentially a multitude of other purposes. As known by those of ordinary skill in the art, the distributed generation of fuels, electricity and heat is an efficient and clean solution for the environment due, in part, to the high technical efficiency of the applicable system. Another advantage is represented by distributed cogeneration of heat and power that can bring the overall performance of the applicable system to exceed, for example, eighty percent (80%). Another advantage in certain system is the absence of polluting emissions from fossil hydrocarbons. In fact, the combustion of fossil hydrocarbons forms polluting gas species such as, for example, NOₓ, CO, HC, SOₓ, PM10, and PM5. Moreover, from fossil sources are produced substances altering the CO₂ balance and the other atmospheric gases.

Conversely, the present invention, which is herein described, uses water that is decomposed into molecules as H₂, O₂ and HO. These molecules are reacted with CO₂, generated from a different water stream or by carbon oxidation. The CO₂ is also recovered from the exhaust gases and/or sourced from another CO₂ emitting source. The primary reaction, which takes place in the reactor in the presence of a catalyst, leads to the formation of a gas mixture that contains CH₄, CO, CO₂, H₂, and O₂. The balance of the CO₂ of the environment is not altered. There are no fossil fuels or biomasses used in the practice of the present invention, and thus no introduction of a notable amount of CO₂ SOₓ, and other harmful gases into the environment deriving from those fuels. Furthermore, the present invention does not produce any particulates since no fuels containing long chains of carbon or ashes are used. The NOx generated are in quantities far below the emissions levels from other existing technologies due to the fact that a part of the oxygen for combustion is generated with the same fuel gas, thereby reducing the amount of ambient air intake needed for the combustion.

In accordance with the present invention, and in more detail, the method of generating the fuel gas and both thermal and electrical energy includes the steps of (A) production of the initial gases, (B) mixing the initial gases and their conversion into the catalytic reactor to form the final formulation of the fuel for the end uses, (C) as desired, generating electric and/or thermal energy, and (D) when appropriate, storing the electrical energy storage and/or exchanging produced thermal energy. The system that comprises the present invention includes the elements needed to perform the steps written above. The inventive product is the result of the performance of the steps, the use of the elements, and the appropriate combination of both.

The gas generation step includes the generation of O₂, OH and H₂ gases. At roughly the same time, the CO₂ generator produces CO₂ gas, which is preferably collected in the storage embedded to the generator itself. Said O₂, OH and H₂ gases pass through the filter and are mixed with CO₂ in the catalytic reactor. One of ordinary skill in the art would know that various embodiments call for the gases to be produced at differing times and in differing locations, noting that the more critical aspect of this part of the method is the appropriate levels of and for the reaction temperature, pressure, filtering and mixing.

The catalytic reactor is preferably maintained at a temperature above 15° C. and below 500° C. The gases, which will have a pressure preferably equal to or higher than 1 bar and lower than 10 bar, are mixed and flow over and in contact with the surface of the catalyst. Said catalyst is composed of Copper, Nickel, Iron, Platinum, Ruthenium, Manganese, Molybdenum, and Cobalt or mixtures between them and these elements are deposited, in fractions, and various quantities, upon different substrates. One of ordinary skill in the art would know that the specific composition and nature of the catalyst may have more beneficial or more negative impact on the physical properties of the resulting fuel gas and other aspects of the process (e.g., the heat and/or electricity generated). Care should be given to use the catalyst that results in outputs that are the closest to those desired by the practitioner.

In the catalytic reactor, the reactions for the formation of CH₄, CO, and H₂O occur. Since such reactions and the resulting formations are incomplete, there is a continued presence of H₂ and O₂ molecules in the final gas mixture exiting from said reaction. The appropriate control of pressure and temperature of gases and the catalyst's proper composition leads to the final gas in the formulation desired.

The water produced in said reaction is preferably recovered in the feed tank of the machine. The final gas may be used for cogeneration, renewable energy storage, transportations, other applications, or a combination of applications. In the case of cogeneration of heat and power, this process could take place inside the preferred embodiment as a domestic furnace producing electricity and hot water or air. The produced heat could be used to power a thermoelectric generator that could produce electricity, and to heat water or air for domestic and industrial purposes, or for a variety of other purposes. The produced electrical energy could also be stored in the battery and/or be used for the process here depicted. In a preferred embodiment of the present invention, the gases resulting from the combustion are separated to recover the CO₂, whilst the residual gases are emitted into the atmosphere. The CO₂ recovered could thereafter be stored into the CO₂ generator.

Through the use of for example, water, electricity, materials, mechanical and electrical parts appropriately configured, the present inventive system provides the production of a gas that can be used for, for example, the generation of power and heat in the civil and industrial sectors, residences, or other venues. Conversely or in addition, the gas can be used as a fuel in the transportations sector, for renewable energy storage, and otherwise.

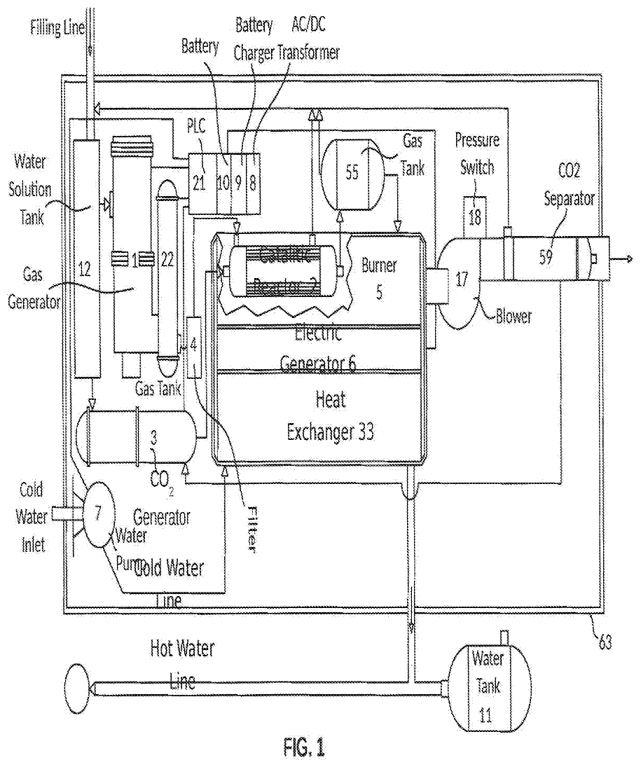

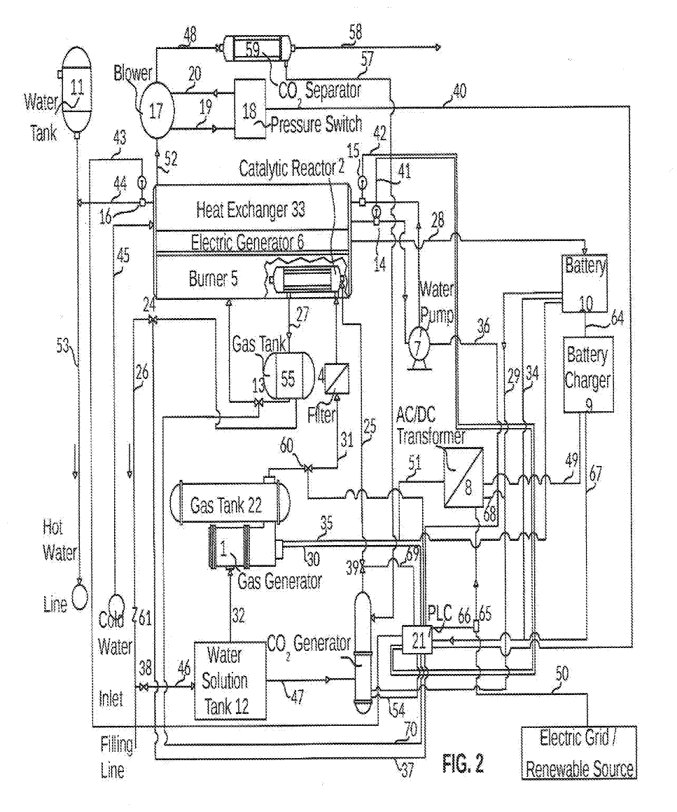

FIG. 1 shows a preferred embodiment of the present invention—realized by a furnace for the generation of heat and electricity. In this particular embodiment of the inventive system, the elements include water reservoir tank 12, electrolytic gas generator 1, gas tank 22, CO₂ generator (with embedded CO₂ buffer tank) 3, gas filter 4, catalytic reactor 2 placed inside the combustion chamber 5, combustion chamber 5, thermoelectric generator 6 embedded in the side of the combustion chamber 5, heat exchanger 33, water circulation pump 7, electrical power supply 8, battery-charger 9, accumulator 10, programmable logic computer 21, gas reservoir tank 55, fan 17, CO₂ separator 59. FIG. 2 shows the inventive system as shown in FIG. 1 with the addition of temperature transducer 14, temperature transducer 15, temperature transducer 16, pressure transducer 18, non-return check valve 61, solenoid valve 13, regulating valve 39, controlled open/close valve 60, electric switch 65, piping, electric cables and the connection relative to said components.

In the use of the inventive system, the electric power from the national grid is used by battery charger 9 for charging the accumulator 10 and, as needed, by electrical power supply 8 to start the process. Also present is electrolytic gas generator 1, which can be filled with water or, as desired or needed, another aqueous solution and which is electrically powered by power supply 8 and controlled by programmable logic computer 21. Programmable logic computer 21 could be comprised of a variety of components and software that allow it to be used to manage various elements of the inventive system. Although the power can be adjusted as needed, the supply voltage preferably varies between 1.5 V [DC] and 240 V[DC], where the current varies accordingly to the voltage and the water solution composition.

In one embodiment of the present invention, battery charger 9 is connected to the power supply 8 from cable 49 and to, and controlled by, the programmable logic computer 21 through cable 67, it is used to charge accumulator 10 by means of electric cable 64. Power supply 8 is preferably connected to a national power grid through cable 50 and is used to start the process carried out by the present invention or a renewable electric energy source. The switch 65, which can be preferably connected to programmable logic computer 21 via electric cable 66, can be operated by programmable logic computer 21 to manage the connecting or disconnecting of power supply 8 from a national electric grid or a renewable electric energy source.

CO₂ generator (with embedded CO₂ buffer tank) 3 is powered by cables 68 and 29; said system can therefore be powered by a national grid when switch 65 is closed and by the battery when switch 65 is open. At start the electrolytic gas generator 1 is filled with water or an aqueous solution and is electrically powered by power supply 8; the voltage of the electric energy varies preferably between 1.5 V [DC] and 240 V [DC], where the current is varied accordingly to the voltage and the water solution.

The gases produced by electrolysis are preferably composed of desirable amounts of O₂, OH and H₂. These gases are collected in gas tank 22, preferably pass through regulating valve 60, are filtered by filter 4 and then sent to catalytic reactor 2, wherein the O₂, OH and H₂ gases are mixed with CO₂ and CO gas. Said CO₂ and CO gases are produced by CO₂ generator (with embedded CO₂ buffer tank) 3, filled with water or another desired solution or set of solutions and powered by electrical power supply 8. Said CO₂ and CO gases are fed to catalytic reactor 2 through regulating valve 39.

Catalytic reactor 2 preferably operates at a temperature of or between 15° C. and 500° C. and at a pressures of or between 1 bar and 10 bar. The reaction between the H₂, O₂, CO₂ and CO takes place in the presence of a catalyst which can be made of, for example, Copper, Nickel, Iron, Platinum, Ruthenium, Manganese, Molybdenum, Cobalt, one or more mixtures of the foregoing or a different material or set of materials known to those of ordinary skill in the art. The reaction time is preferably between 1 second and 15 seconds, with a more preferred reaction time between 3 seconds and 6 seconds.

Said reaction is exothermic and produces H₂O, CH₄, CO, CO₂, H₂ and O₂, with the efficiency of the reaction preferably higher than eighty percent (80%) and below 90% (for at least one embodiment, below 98%). The water, formed in catalytic reactor 2 and condensed into gas reservoir tank 55, is fed back into the process, respectively, through conduit 63 and tube 26 in which is inserted non-return check valve 61. Finally, the H₂O is entered through pipe 46, which holds the regulating valve 38, in the water reservoir tank 12, then in the electrolytic gas generator 1 and in CO₂ generator (with embedded CO₂ buffer tank) 3.

The remaining gas, accumulated in gas reservoir tank 55, are introduced into combustion chamber 5, where they are burned with atmospheric air to produce heat. The flow of gas from gas reservoir tank 55 to combustion chamber 5 is controlled by safety solenoid valve 13, which is preferably connected to and actuated by programmable logic computer 21.

In one preferred embodiment of the present invention, heat is transferred to the thermoelectric generator 6 embedded into the combustion chamber 5 and subsequently to heat exchanger 33. The thermoelectric generator 6 preferably operates between 300° C. and 95° C., producing DC electrical energy having voltage preferably in the range 13 V-14 V, which is sent to accumulator 10; said accumulator 10 would be preferably connected to and controlled by programmable logic computer 21. Heat exchanger 33 preferably operates at a temperature of 95° C. (on the hot side) and heats up the water coming from the heating circuit and water tank 11, with the water being pumped by water circulating pump 7, which is connected to and controlled by programmable logic computer 21.

The temperature of the water entering heat exchanger 33 is preferably detected by temperature transducer 15, while the temperature at the exit of heat exchanger 33 is detected by temperature transducer 16. Both of temperature transducers 15 and 16 are preferably connected to and controlled by programmable logic computer 21. Temperature transducer 14, connected to and controlled by programmable logic computer 21, preferably detects the temperature of the recirculating water pumped by water circulation pump 7.

In a further preferred embodiment of the present invention, the gases produced by the combustion in combustion chamber 5 are blown to CO₂ separator 59 by fan 17 connected to pressure transducer 18, which is in turn preferably connected to and controlled by programmable logic computer 21. The CO₂ recovered from combusted gases goes into the CO₂ generator (with embedded CO₂ buffer tank) 3 and is fed to the process. The remaining gases are released into the atmosphere through exhaust 58.

In another preferred embodiment of the present invention, the gas produced and accumulated in gas reservoir tank 55 is used as a fuel for transportation, for civil and industrial applications, and for similar purposes. This product is also of a physical nature that it can be stored and transport with little concern of unintended combustion and for use in renewable energy storage.

The relative propositions of the gases that mix and react in catalytic reactor 2 are carefully regulated by regulating valve 60 regarding to the H₂ and O₂ gases, and by regulating valve 39 with regarding to the CO₂ and CO gases. These valves regulate the flow of gases in order to convert a substantial portion of H₂, O₂, CO₂ and CO into CH₄ and H₂O. The reactions between CO with O₂ and between H₂ with CO₂ are exothermic and contribute to maintaining the operating temperature in a range which is preferably between 100° C. and 400° C. The weight ratio between CO₂ and H₂ is in the range from 50 to 1, for example about 44 to 2 and the atomic ratio between oxygen and carbon monoxide is in the range from 0.5 to 3, for example about 1 to 2. The atomic ratio between CO₂ and CH₄ is in the range from 0.5 to 2, the atomic ratio between H₂ and H₂O is in the range from 1 to 3. The atomic ratio between H₂ and CO₂ is between 0.5 to 4 (or to 6, depending upon the embodiment), where the atomic ratio between CO₂ and H₂O is in the range from 1 to 2. The reaction occurring into catalytic reactor 2 is exothermic and produces as a final gas mixture formed by H₂O, and CH₄, and in a smaller amount by CO, CO₂, H₂ and O₂, being the overall efficiency of the reactor and the reactions lower than 90%, but one skilled in the art would know that the efficiency could be higher if the invention can be practiced in ways to reduce the amount of the unconverted reactants. Said gases are accumulated in gas reservoir tank 55 connected to reactor 2 from pipe 27. Here the gases are cooled to a temperature below 95° C., and the H₂O is condensed. This water is recovered via conduit 63, control valve 24 and tube 26 in which non-return check valve 61 is inserted.

Finally, the H₂O is introduced into water reservoir tank 12 through pipe 46, which holds the regulating valve 38. The fuel gas accumulated in gas reservoir tank 55 is fed into combustion chamber 5, where they are burned to produce heat. The flow of gas from gas reservoir tank 55 to combustion chamber 5 is controlled by safety solenoid valve 13, which is connected to and actuated by programmable logic computer 21. In a preferred embodiment of the present invention, the heat of combustion gases is transferred to thermoelectric generator 6 and then to the heat exchanger 33. In this way, the thermoelectric generator 6 produces electricity as direct current. Said electricity is sent to accumulator 10, which is connected to and controlled by programmable logic computer 21. Heat exchanger 33 is embedded into a wall of thermoelectric generator 6, being heated with this. The heat exchanger transfers the heat to the water coming from the heating circuit and water tank 11. The water is placed in circulation by water circulation pump 7 connected to and controlled by programmable logic computer 21.

The CO₂, when recovered, is sent in CO₂ generator 3 and fed back into the process. The remaining gases are released into the atmosphere through exhaust 58. Temperature sensor 14 signals the limit temperature at which programmable logic computer 21 starts water circulation pump 7. Temperature transducer 15 signals the upper limit temperature of the water so that programmable logic computer 21 acts on the solenoid valve 13 to regulate the combustion in the combustion chamber 5. Pressure transducer 18 detects the exhaust gas pressure from the combustion chamber 5 sending the signal to programmable logic computer 21 for the regulation of the combustion.

The electricity generated by thermoelectric generator 6 charges accumulator 10. Accumulator 10 is connected to and controlled by programmable logic computer 21 in such a way that it can power the process when switch 65 is open to allow the autonomous operation of the system. Water pump 7 is controlled and operated by programmable logic computer 21. Water pump 7 is electrically supplied by a national electric grid with an external circuit to the present invention not shown here.

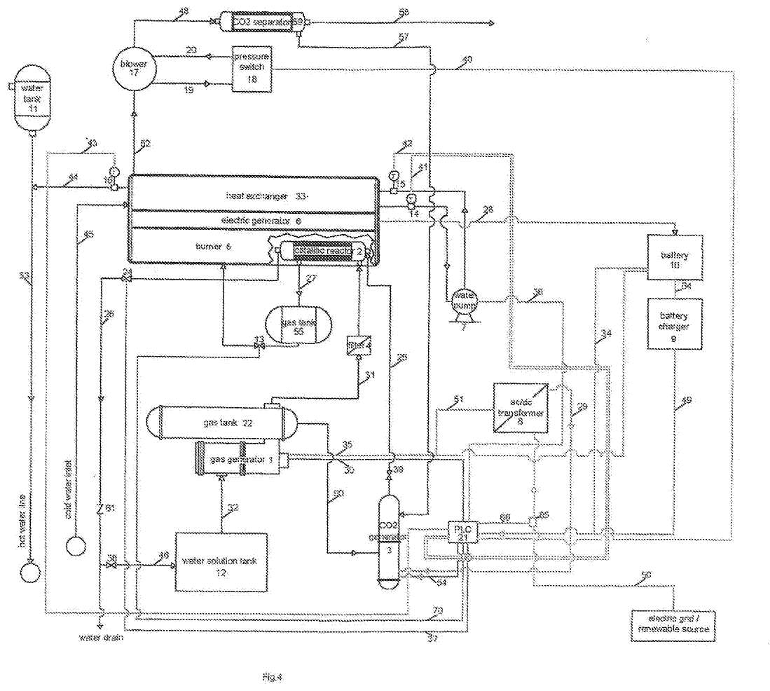

FIG. 4 shows an embodiment of the inventive system with many of the elements shown in FIG. 2. One notable difference that water from water tank 12 does not enter directly into CO₂ generator 3. In FIG. 4, there is no equivalent to pipe 47 show in FIG. 2. Instead, gas from gas tank 22 is fed into CO₂ generator 3 via pipe 90. As a result of this alternation, the function of CO₂ generator 3 becomes the oxidation of carbon through oxygen. In essence, CO₂ generator 3 functions as an auto-thermal reactor. With regard to the process, this alternation results in there is contemporaneous production of CO₂ gas along with the carbon reacting with the oxygen in gas generator 1. In a preferred embodiment, the CO₂ is produced using a voltage between 1 V [DC] and 240 V [DC] and 1 V [AC] and 400 V [AC].

In an additional embodiment, the inventive system includes a CO₂ recovery system that recovers the CO₂ from any source and/or deposit of CO₂, as for example, from the atmosphere, flue gases, other gases containing CO₂, or a combination of the foregoing (e.g., biogas plants, oil and gas extraction plants, gas produced from any gasification or pyrolysis or combustion plants and systems, biological sources of CO₂, such as water treatment plants, sewage plants, fermentation systems, such as wineries, breweries, distilleries, CO₂ from petrochemical industries, cement and limestones facilities, solid waste treatment plants, fossil and renewable fuel combustion, transportation sector, underground CO₂ storages). Such recover could be either combined with or separate from the CO₂ storing means and/or the internal CO₂ generation system.

One of ordinary skill in the art would recognize the benefit of pairing one or more CO₂ separation technologies with CO₂ recovery system to improve the performance of the present inventive system. CO₂ separation technologies and methods commonly employed to separate and capture CO₂ for further uses include, without limitation, the following: absorption, adsorption, cryogenic distillation and membranes system. By way of further example, absorption systems used in this regard could be chemical based (e.g., employing monoethanolamide (MEA), caustic, ammonia solutions) or physical elements (like, for example, a Rectisol process, a Selexol solvent, or fluorinated acids systems). In an alternative manner, an adsorption systems might be chemical based (employing, for example, CaO, MgO, Li₂ZrO₃, Li₄SiO₄) or be embodied as a physical system (such as, for example, Alumina, zeolite, activated carbon systems). Examples of membrane systems would include those that employ ceramic membranes, gas separation (e.g., polyphenyleneoxide and polydimethyisiloxane), gas absorption (like, for instance, polypropylene systems) and polymeric and inorganic membranes. Further, the list of possible solvents employed in such a process include, for example, ionic liquids, aqueous piperazine, amino acid and aqueous amino acid salts, ammonia, alkanolamines (e.g., MEA, diethanolamine (DEA), and methyldiethanolamine (MDEA)), glycol, glycol carbonate, methanol, fluorinated solvents, and dimethyl ether of polyethylene glycol.

By way of further disclosure, although it is noted that (A) the methanation process was discovered in 1902 (by Sabatier and Senderens); (B) water alkaline electrolyzers and solid oxyde electrolisyzers, polymer electrolyte membrane electrolyzers are known and several applications have been made in last 50 years CO₂ capture and recovery systems from flue gases, exhausted gases, biogas, air and other sources are known since decades; (C) several type of CO₂ capture systems have been investigated, published and commercialized in the last decades (such as solid sorbents, liquid sorbents, amine, membranes, ionic liquids, and so on) and reference like Schulz and Kaneeda disclose some of the foregoing, one skilled in the art would not gleam from such prior art the CO₂ capture process, procedures, catalysts and devices of the present invention.

For instance, where, as elaboration, Schulz discloses an older use of methanation reaction/reactors, even in commercial applications, the present invention does not require such an external heating system to operate. The CO₂ recovery from exhaust gases and flue gases, the storage of CO₂, the water separation/condensing from methane, all of the previous are two decades old state of the art, referenced in Kaneeda and Schulz in their inventions. Thus, noting that for one skilled in the art might see the capture of CO₂ from an exhaust gas is an old proven technology, conversely the CO₂ internal production system of the present invention nevertheless differs from the approach taught or suggested by Kaneeda, Schulz or elsewhere in the prior art.

To be clear, the combustion chamber of the present invention is a burner for stationary application, as opposed to an internal combustion engine, as disclosed in Kaneeda. In fact, as an elaboration on and in distinguishing the present invention, Kaneeda teaches a means of storing CO₂, whereas the present invention includes the elements that produce the gas. The present invention consists of the production of a fuel gas, electricity and usable heat by a stationary system (not automotive neither internal combustion engines).

In short, although the present invention may include several commercial devices (i.e., the hydrogen in produced by a water electrolyzer) and processes (such as for example, technology disclosed in Kaneeda and Schulz) the arrangement of the components of the present invention and the processes are not taught or disclosed. Restated, the present invention pertains to device/system to produce fuel gases, heat and electric energy; produces CO₂/CO by a proper device, not by an internal combustion engine that is designed to convert chemical energy into mechanical power; recovers CO₂ generated by the combustion of said fuel gas when this fuel gas is used as fuel in an embodiment comprising a burner and combustion chamber, a thermoelectric generator, a hot water heat exchanger, a CO₂ capture system; produces electricity using a thermoelectric generator instead of using rankine cycles generators nor internal combustion engines.

One of ordinary skill in the art would know that the present invention as a method could be used in lieu of or in addition to a multitude of methods with various configurations that produce gas, heat, electricity or any combination of the forgoing. In parallel, one of such skill would realize that the application of the present invention as a system could be in conjunction with or as a replacement for any number of systems that use gas, heat, electricity or any combination of the foregoing in their operations, such as, for example, internal combustion engines, gas turbines engines and prime movers, and larger furnaces. Correspondingly, the gas fuel produced through the practice of the inventive method and/or the inventive system could be use in the same fashion and ways as other combustible fuels.

What is claimed is:

1. A method of efficiently producing a combustible gas, without producing polluting emissions from fossil hydrocarbons, comprising the steps of
a) producing primary gases by water electrolysis;
b) mixing and filtering such primary gases;
c) internally producing CO₂ gas using a voltage between 1 V [DC] and 240 V [DC] and 1V [AC] and 400 V [AC];
d) storing such CO₂ gas;
e) mixing the filtered primary gases with the previously produced CO₂ gas (and CO gas) in a catalytic reaction at a temperature above 15° C. and below 500° C. and at a pressure higher than 1 bar and lower than 10 bar wherein the gas mixture is conveyed over the surface of a desired catalyst;
f) releasing undesired and unneeded molecules;
g) collecting the final gas formulation, having the desired chemical and physical properties;
h) recovering water produced through the process; and
i) recovering any residual CO₂ gas for use in the process in combination with the produced/stored CO₂ gas.

2. The method of claim 1 wherein the catalytic reaction produces a hot gas flow composed of CH₄ and H₂ CO₂ and H₂O.

3. The method of claim 1 wherein the final gas formulation is burned to produce heat.

4. A system, through which combustible gas can be efficiently produced, without producing polluting emissions from fossil hydrocarbons, comprising:
a) a means of producing primary gases through water electrolysis;
b) a means of mixing and filtering such primary gases;
c) a means of producing CO₂ gas;
d) a means of storing such CO₂ gas
e) a means of mixing the filtered primary gases with the previously produced CO₂ gas (and CO gas) in a catalytic reactor at a temperature above 15° C. and below 500° C. and at a pressure higher than 1 bar and lower than 10 bar;
f) a means of conveying the primary gas/CO₂/CO gas mixture over the surface of a desired catalyst;
g) a means of releasing undesired and unneeded molecules;
h) a means of collecting the final gas formulation with the desired chemical properties;
i) a means of recovering water produced through the process; and
j) a means of recovering any residual CO₂ gas for use in the process in combination with the produced/stored CO₂ gas.

5. The system of claim 4 wherein the means of producing primary gases through water electrolysis receives a water solution from areservoir.

6. The system of claim 4 wherein such filtering cleans the gases produced through electrolysis.

7. The system of claim 4 further comprising means for conveying the produced gas to the filter and means for conveying and regulating the gas flow towards the catalytic reactor.

8. The system of claim 4 further comprising a programmable logic computer system controlling and adjusting the system and process.

9. The system of claim 4 further comprising
a) a combustion chamber for the generation of thermal energy containing inside the catalytic reactor;
b) means for conveying and regulating the gas flow towards such combustion chamber;
c) a thermoelectric generator embedded to such combustion chamber for the production of electric energy;
d) means for using the electric energy produced to charge the battery;
e) a heat exchanger to transfer the heat generated in such combustion chamber to a desired element;
f) means for separating CO₂ from exhaust gases;
g) a fan for conveying exhaust gases from such combustion chamber to such means of separating CO₂;
h) a programmable logic computer to control and regulate the operation of the machine and the process;
i) means for detecting the water and the air temperature at the outlet of said heat exchanger and for the regulation of the water or air circulation;
j) means for detecting the temperature of the incoming water and air to said heat exchanger for adjusting the flow of said water or air;
k) means for water or air circulation through said heat exchanger with water or air;
l) means for pushing the flue gas through the CO₂ separator and towards the exhaust;
m) means for the transport of said recovered CO₂ to the CO₂ generator; and
n) means to connect the programmable logic computer to said temperature sensor, said pressure sensor, said control valves and said electric switches.

10. A combustible fuel gas produced through the practice of the method of claim 1.

11. A combustible fuel gas produced through the practice of the system of claim 4.
